(19) United States
(12) Patent Application Publication
(10) Pub. No.: US 2010/0042470 A1
(43) Pub. Date: Feb. 18, 2010

(54) CONTEXT BASED ADVERTISEMENT FILTRATION

(75) Inventors: Eric I. Chang, Beijing (CN); Raman Chandrasekar, Seattle, WA (US); Tian Bai, Beijing (CN); Michael Tsang, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/193,681

(22) Filed: Aug. 18, 2008

(51) Int. Cl. G06Q 30/00

(52) U.S. Cl. 705/10; 705/14.4

(57) ABSTRACT

A software and/or hardware facility for filtering advertisements based on variable contexts is described. The facility may ascertain whether incoming messages are advertisements and filter messages containing advertisements. Advertisements may be filtered for deletion, storage, and/or user alerts with or without storage. The user may be alerted to incoming advertisements either upon receipt or at a later time. Filtering and notification may be based on real-time context (e.g., mood, location, time, environment, device status, etc.). In addition, filtering may also be based on message context and other contexts. User feedback may also be employed to refine filtering algorithms.

### BACKGROUND

Electronic messaging services such as Short Message Service (SMS) messaging, Multimedia Message Service (MMS) messaging, email, and instant messaging (IM) are being increasingly used for both business and personal purposes. Electronic messaging has many advantages over nonelectronic messaging such as postal mail. These advantages include low cost, rapid delivery, and ease of storage. Also, mobile communications services such as wireless telephony, wireless data services, and wireless email are being increasingly used for both business and personal purposes. By combining electronic messaging services and mobile communication services, users may experience real-time or near real-time delivery of electronic communications regardless of time and location.

As the cost of electronic communications services decreases, advertisers are increasingly delivering both targeted and nontargeted advertisements to users via these services. Users may desire to receive certain desirable advertisements regardless of their current situation, to receive other desired advertisements only during certain situations, and to never receive some advertisements. Likewise, advertisers and advertisement service providers may desire to target advertisements to more receptive audiences. For example, advertising targeted to receptive audiences may result in increased acceptance of the advertisement, a higher click-through rate, increased sales, and increased revenue for both advertisers and advertisement service providers.

### SUMMARY

A software and/or hardware facility for filtering advertisements based on variable contexts is described. The facility may ascertain whether incoming messages are advertisements and filter messages containing advertisements. Advertisements may be filtered for deletion, storage, and/or user alerts with or without storage. The user may be alerted to incoming advertisements either upon receipt or at a later time. Filtering and notification may be based on real-time context (e.g., mood, location, time, environment, device status, etc.). In addition, filtering may also be based on message context and other contexts. User feedback may also be employed to refine filtering algorithms.

This Summary is provided to introduce a selection of concepts in a simplified form that are further described in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a suitable environment for practicing the invention.

FIG. 2 illustrates a system for filtering messages based on various inputs and feedback.

FIG. 3 is a logical flow diagram of a process for filtering messages.

FIGS. 4A-4F illustrate an organizational structure into which received messages may be filtered.

FIG. 5 is a logical flow diagram of a process for sorting advertisements.

### DETAILED DESCRIPTION

A software and/or hardware facility for filtering advertisements based on variable contexts is described. The facility may ascertain whether incoming messages are advertisements and filter messages containing advertisements. Advertisements may be filtered for deletion, storage, and/or user alerts with or without storage. The user may be alerted to incoming advertisements either upon receipt or at a later time. Filtering and notification may be based on real-time context (e.g., mood, location, time, environment, device status, etc.). In addition, filtering may also be based on message context and other contexts. User feedback may also be employed to refine filtering algorithms.

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. The term “based on” is not exclusive and is equivalent to the term “based, at least in part, on” and includes being based on additional factors, whether or not the additional factors are described herein. Although certain terms may be emphasized below, any terminology intended to be interpreted in any restricted manner will be overtly and specifically defined as such in this Detailed Description section.

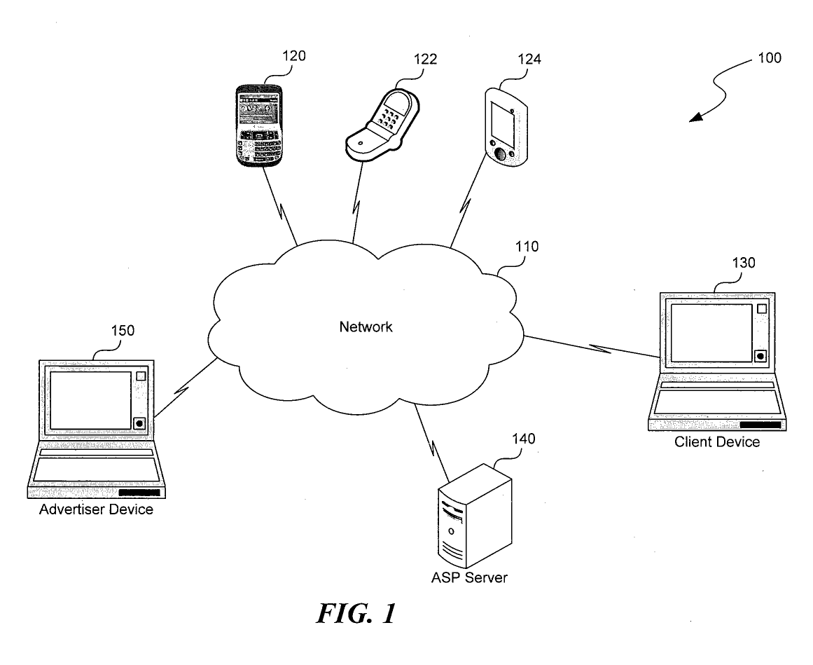

FIG. 1 illustrates a suitable environment in which the invention may be practiced. However, various modifications such as inclusion of additional devices, consolidation and/or deletion of various devices, and shifting of functionality from one device to another device may be made without deviating from the invention. Environment 100 includes network 110, mobile devices 120, 122, and 124, client device 130, application service provider (ASP) server 140, and advertiser device 150.

Network 110 is configured to interconnect various computing devices such as mobile devices 120, 122, and 124, client device 130, ASP server 140, and advertiser device 150 to each other and to other resources. In addition, network 110 may include any number of wired and/or wireless networks, including the Internet, intranets, local area networks (LANs), metropolitan area networks (MANs), wide area networks (WANs), personal area networks (PANs), direct connections, and/or the like. Additional computing devices such as routers, network switches, hubs, modems, firewalls, gateways, Radio Network Controllers (RNCs), proxy servers, access points, base stations, and/or the like may be employed to facilitate communications.

Further, the various computing devices may be interconnected with T-1 connections, T-3 connections, OC-3 connections, frame relay connections, Asynchronous Transfer Mode (ATM) connections, microwave connections, Ethernet connections, token-ring connections, Digital Subscriber Line (DSL) connections, and/or the like. In addition, network 110 may also utilize any wireless protocol and/or standard. These include, for example, Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Universal Mobile Telecommunications System (UMTS), Advanced Mobile Phone System (AMPS), Worldwide Interoperability for Microwave Access (WiMAX), Wireless Fidelity (WiFi), and/or the like.

Mobile devices 120, 122, and 124 may include virtually any portable computing devices capable of receiving and sending messages over a network, such as network 110. Such devices include portable devices such as cellular telephones, display pagers, radio frequency (RF) devices, infrared (IR) devices, Personal Digital Assistants (PDAs), handheld computers, laptop computers, wearable computers, tablet computers, integrated devices combining one or more of the preceding devices, and/or the like. As such, mobile devices 120, 122, and 124 range widely in terms of capabilities and features. For example, a cellular telephone may have a numeric keypad and the capability to display only a few lines of text. However, other cellular telephones (e.g., smart phones) may have a touch-sensitive screen, a stylus, and a relatively high-resolution display.

Mobile devices 120, 122, and 124 may typically include a processing unit, volatile memory and/or nonvolatile memory, a power supply, one or more network interfaces, an audio interface, a display, a keypad or keyboard, a Global Positioning System (GPS) receiver and/or other location determination device, and other input and/or output interfaces. Also, the various components of mobile devices 120, 122, and 124 may be interconnected via a bus.

The volatile and nonvolatile memories generally include computer storage media for storing information such as computer readable instructions, data structures, program modules or other data. Some examples of information that may be stored include basic input/output systems (BIOS), operating systems, and applications. In addition, the memories may be employed to store operational data, content, contexts, and/or the like.

The memories may also store one or more client applications that are configured to receive and/or provide messages from and/or to another computing device. These messages may also be displayed and/or stored on mobile devices 120, 122, and 124. In addition, the messages may include SMS messages, MMS messages, instant messaging (IM) messages, enhanced message service (EMS) messages, and/or any other content directed towards a user of mobile devices 120, 122, and 124 such as audio data, multimedia data, photographs, video data, still images, text, graphics, animation files, voice messages, and text messages. The one or more client applications may also provide message filtering and notification based on varying contexts.

Mobile devices 120, 122, and 124 may also provide identifiers to other computing devices. These identifiers may include identification of a type, capability, and/or name of the particular mobile devices. In one embodiment, mobile devices 120, 122, and 124 may uniquely identify themselves and/or identify a group association through any of a variety of mechanisms, including a phone number, a Mobile Identification Number (MIN), an electronic serial number (ESN), a Media Access Control (MAC) address, a personal identification number (PIN), an RF signature, and/or other identifier.

Client device 130 may include virtually any computing device capable of communicating over a network. Typically, client device 130 is a computing device such as a personal computer (PC), multiprocessor system, microprocessor-based or programmable consumer electronic device, and/or the like. In addition, client device 130 may be a television, digital video recorder, media center device, set-top box, other interactive television device, and/or the like. Also, client device 130 may be configured to enable a user to communicate with ASP server 140 to configure preferences, provide context information, and/or the like. In addition, client device 130 may also be utilized to filter and forward (e.g., redirect) messages to a user's mobile device based on varying contexts.

ASP server 140 may include any computing device capable of connecting to network 110 to provide advertising and/or other messages to mobile devices 120, 122, and 124 and/or client device 130. Devices that may operate as ASP server 140 include personal computers, desktop computers, multiprocessor systems, microprocessor-based or programmable consumer electronic devices, servers, and/or the like. Likewise, ASP server 140 may include a single computing device, the functionality of ASP server 140 may be distributed across multiple computing devices, or ASP server 140 may be integrated into another device such as an SMS gateway, an advertisement server, and/or the like.

Advertiser device 150 may include virtually any computing device capable of communicating over a network. Typically, advertiser device 150 is a computing device such as a personal computer, multiprocessor system, microprocessor-based or programmable consumer electronic device, and/or the like. Also, advertiser device 150 may be utilized by an advertiser to provide advertisements and/or other messages to ASP server 140 and/or mobile devices 120, 122, and 124. In addition, advertiser device 150 may also be employed to provide information corresponding to advertisements such as targeting information, advertising budget, advertising campaign characteristics, advertiser information, and/or the like.

Additional details regarding mobile devices 120, 122, and 124, client device 130, ASP server 140, advertiser device 150, and the functionalities thereof are discussed below.

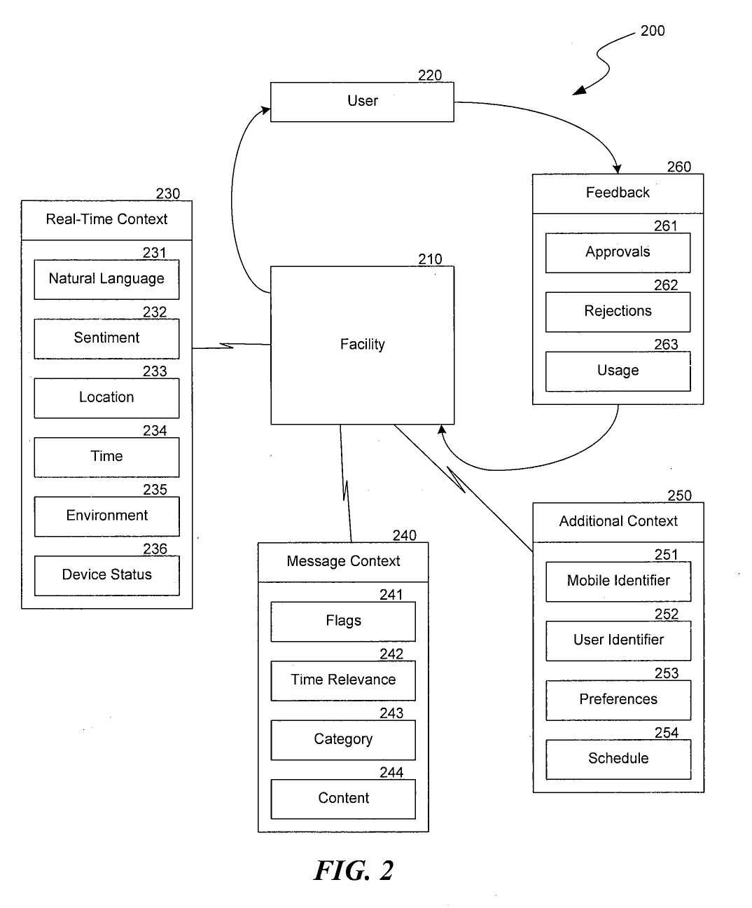

FIG. 2 illustrates message filtration and notification system 200. As illustrated, system 200 includes facility 210, which is configured to receive inputs from multiple sources, to filter messages, and to selectively alert user 220 to arriving messages. The input sources may include real-time context module 230, message context module 240, additional context module 250, and feedback module 260. For clarity, system 200 and the functionalities thereof are described below as being performed by particular elements of environment 100 of FIG. 1. However, system 200 and the functionalities thereof may also be, for example, performed by or on other processors, elements, or devices whether or not such processors, elements, or devices are described herein.

Facility 210 may include a software and/or hardware facility that receives messages, filters the messages, and selectively alerts user 220 to arriving messages based on the various contexts. For example, facility 210 may enable filtration of incoming messages with an adaptive filtration algorithm. Facility 210 may be implemented on any device. For example, facility 210 may be implemented on mobile devices 120, 122, and 124, client device 130, or ASP server 140 of FIG. 1. However, facility 210 may also be implemented on any other suitable device. Likewise, the illustrated input sources are provided merely to illustrate some of the many possible input sources for such a facility. In other systems, other, different, fewer, and/or additional inputs may also be suitably employed.

Facility 210 may receive input from real-time context module 230 to account for the real-time state and/or current state of user 220 and mobile device 120. Real-time context module 230 may include natural language module 231, sentiment module 232, location module 233, time module 234, environment module 235, and device status module 236.

Natural language module 231 and sentiment module 232 are respectively configured to provide natural language and sentiment information to facility 210. As one example, natural language and sentiment information may be based on user 220's interaction with or through, for example, mobile device 120 and may include the textual, speech, and physiological information and may be extracted from text messages, mobile browser queries, voice messages, telephonic discussions, notes, and/or any other information available to mobile device 120.

In one example, natural language information may be analyzed to determine the subject matter of user 220's interaction with mobile device 120. Likewise, sentiment information may be analyzed to determine user 220's emotional state, attitude, needs, or intent. For example, a mood, stress level, workload, and/or the like of user 220 may be inferred based on analyzing sentiment information. In addition, natural language and/or sentiment information may be analyzed to infer user context and/or user intent.

Natural language and/or sentiment analysis may employ any suitable analysis algorithms, methods, procedures, and/or the like. For example, natural language processing algorithms, voice recognition algorithms, pattern matching algorithms, computational linguistics algorithms, text mining algorithms, semantic analysis algorithms, vector analysis algorithms, and/or the like may be employed to analyze natural language and/or sentiment information. Custom and/or situational-specific vocabularies, libraries, models, and/or the like may also be employed.

Natural language and/or sentiment information may be extracted by mobile device 120 for on-board analysis and/or analysis at client device 130 and/or ASP server 140. However, natural language and/or sentiment information may be extracted at any other suitable computing device such as ASP server 140, a wireless communications services base station, and/or the like. For example, natural language and/or sentiment information may be extracted by a wireless communications services base station in communication with mobile device 120.

Location module 233 may be employed, for example, to determine the location of mobile device 120. The location of mobile device 120 may be determined by GPS, triangulation from broadcast tower signals and/or WiFi access point signals, manual entry by the user, schedule information, or any other location determination technique. This location information may be employed to provide geographically relevant advertisements, such as coupons, notifications, and/or offers. In addition, location information may further include speed and/or directional information relating to the user 220's mobile device. For example, speed and/or directional information may be employed to determine whether message delivery is currently appropriate and/or to provide geographically relevant advertising at a predicted destination and or along a predicted route.

Time module 234 may be employed to determine the current time and/or to measure durations of time. Time module 234 may include a clock, a timer, or a component to determine time from a broadcast time signal, a GPS signal, or from any other time source. For example, time information may be employed by itself or in conjunction with other information to determine whether message delivery is currently appropriate (e.g., during daytime hours, while user 220 is not in a business meeting, etc.).

Real-time context module 230 may also include environment module 235 to ascertain or receive environmental information. For example, environmental information may include ambient temperature, body temperature, heart rate, humidity, pressure, current weather, traffic conditions, motion and/or orientation of mobile device 120, proximity to other mobile devices, and/or the like. Mobile device 120 may include various sensors to sense these and other examples of environmental information. However, certain examples of environmental information may be sensed at or by a server and/or provided by a third party. For example, proximity to other mobile devices may be determined at a communications service provider server, and current weather information may be provided by a third party weather service.

Device status module 236 may also be employed to provide device status information to facility 210. In one example, device status information includes a status of mobile device 120 such as whether mobile device 120 is currently employed for processing a voice telephone call, Internet browsing, processing email, playing music or video, and/or the like. Likewise, device status information may also include whether the mobile device is in a wireless communications service area, what the signal strength of a wireless communications signal is, whether peripheral devices (e.g., data storage devices, 10 devices, etc.) are connected, and/or the like.

Message context module 240 may be configured to provide context information to facility 210 based on the contents of an incoming message. These contents may include the message itself as well as any data transmitted along with the message or otherwise corresponding to the message. As illustrated, message context module 240 includes flags module 241, expiration module 242, category module 243, and content module 244.

Flags module 241 may pass along or generate flags for identifying, categorizing, and/or sorting messages. Examples of suitable flags include an advertisement flag, an approved advertisement flag, a new message flag, a read message flag, a junk message flag, a low-priority message flag, a high-priority message flag, an urgent flag, and/or the like. In one system, an advertisement flag is inserted into messages suspected of being unapproved advertisements and an approved advertisement flag is inserted into messages containing advertisements that have been preapproved by user 220 and/or by an ASP. For example, approved advertisements may include advertisements from advertisers who have paid a fee for insertion of an approved advertisement flag.

Time relevance module 242 may be employed to provide information regarding the timing of an advertisement to facility 210. Examples of such information include an expiration date and/or time of an offer, an event date and/or time, operating hours of an advertiser, and/or the like. In one system, the time relevance information may be employed to set an urgent or high-priority flag.

Category module 243 may provide any type of category information regarding a message such as information for categorizing advertisement messages by a value of the offer (e.g., dollar amount of discount, percentage amount of discount, free, no discount, etc.), by the type of offered product (e.g., food, clothes, electronics, events, etc.), by the type of message (e.g. video advertisement, text message, voice mail message, etc.), timing of offer, user-defined categories, and/or the like.

Content module 244 may provide information relating to any other content of a message. For example, this information may include information regarding the message sender, recipient, sponsor, message subject, body text, headers, and/or the like. This information, for example, may be analyzed by facility 210 to determine whether incoming messages are advertisements and, if so, to determine their nature.

Additional context module 250 may provide any other context information useful for filtering messages. As shown, additional context module 250 includes mobile identifier module 251, user identifier module 252, preferences module 253, and schedule module 254.

Mobile identifier module 251 and user identifier module 252, respectively, may provide any useful mobile and/or user identifiers to facility 210. For example, mobile identifiers may include device identifiers discussed above with respect to FIG. 1. In addition, user identifiers may include usernames or other identifiers corresponding to user 220. For example, facility 210 may employ a user identifier if user 220 uses multiple mobile devices or if multiple users share a single mobile device.

Further, a user identifier may consist of or include a group association identifier to identify, for example, a group of users that share one or more characteristics. Such characteristics may include geographic characteristics (e.g., location, population density (urban, semi-urban, rural), climate, etc.); demographic characteristics (e.g., age, gender, family size, education, income, occupation, socioeconomic status, religion, ethnicity, language, etc.); and/or behavioral characteristics (e.g., product usage rate, brand loyalty, readiness to buy, income status, etc.). Any population of individuals may be divided into two or more group associations by facility 210, such that the characteristics of each group association may provide information that is useful to target advertisements or services to a user in that respective segment. These characteristics may also be determined by information received from user 220, received from a third party, and/or inferred through user 220's use of mobile device 120.

Preferences module 253 and schedule module 254 may provide user configurable preferences, configuration data, and/or schedule information to facility 210. This information may include the hours user 220 is willing to receive advertisements, user 220's dietary preferences, user 220's typical and/or anticipated travel, calendar and/or other schedule information, and/or the like. Also, calendar and schedule information may include information regarding user 220's business meetings, personal meetings, events, task list, and/or the like.

Additional preference information may be determined by observing text that user 220 has entered, past searches that user 220 has performed, bookmarks that have been saved by user 220, messages user 220 may have sent or received, or other indications of subject matter of interest to user 220. For example, mobile device 120 may include a record of user 220's pattern of use of certain words, phrases, URLs, etc. As another example, mobile device 120 or ASP server 140 may include a record of purchases made by user 220. As yet another example, mobile device 120 may include a record of user 220's entertainment media, such as available audio and video media titles that are stored on or accessible via mobile device 120.

Feedback module 260 may be employed to continuously and/or periodically improve facility 210 by accounting for user 220's previous interactions with facility 210. These interactions may be analyzed to define user 220's preferences, identify instances of previous message miscategorization, and improve/refine the accuracy of a message processing algorithm and/or a model of user 220's behavior.

As one example, feedback module 260 may include approval module 261, rejection module 262, and usage module 263. Approval module 261 and rejection module 262 may provide information regarding user 220's previous approval or rejection of facility 210's previous message filtering of messages. For example, feedback module 260 may include an interface via which user 220 may indicate a correct or incorrect filtering of a message.

Usage module 263 may provide usage data indicative of user 220's interaction with previously presented messages. For example, usage data may include whether user 220 viewed an advertisement, requested further information, made a purchase, saved a message for later viewing, printed an advertisement, and/or the like.

In operation, information from these and other modules may be employed to determine whether an incoming message should be deleted, provided to user 220 upon receipt, stored for later presentation, and/or the like. This determination may include analysis of the various inputs to infer whether a given incoming message is likely to be of value or interest to user 220. By considering the real-time context, facility 210 may enable delivery of incoming messages to user 220 in a more appropriate and less disruptive fashion as compared to delivering all incoming messages to user 220 upon receipt. For example, location- and/or time-sensitive advertisements for products that are known to be of interest to user 220 may be assigned a higher notification priority than location- and time-insensitive advertisements that are not known to be of interest to user 220. Such priority assignment may increase the likelihood that user 220 is notified of advertisements during relevant time periods, while user 220 is near the relevant location, while user 220 is shopping for an advertiser's product, and/or the like.

These and other inputs may also be employed to target advertisements to the preferences of user 220 and increase the relevance and impact of the advertising on user 220. For example, facility 210 may employ the inputs to delay notification of incoming messages while user 220 is busy, is in a business meeting, is driving, is occupied with an urgent task, is participating in a telephone call, and/or the like. However, facility 210 may also employ the inputs to notify user 220 of incoming messages upon receipt or while user 220 is waiting at a stoplight, is talking a walk, is listening to music, and/or like.

The above examples are provided to illustrate the operation of facility 210. However, these examples merely illustrate some of the many possible inputs for facility 210 and some of the many ways in which facility 210 may utilize various inputs to selectively filter messages.

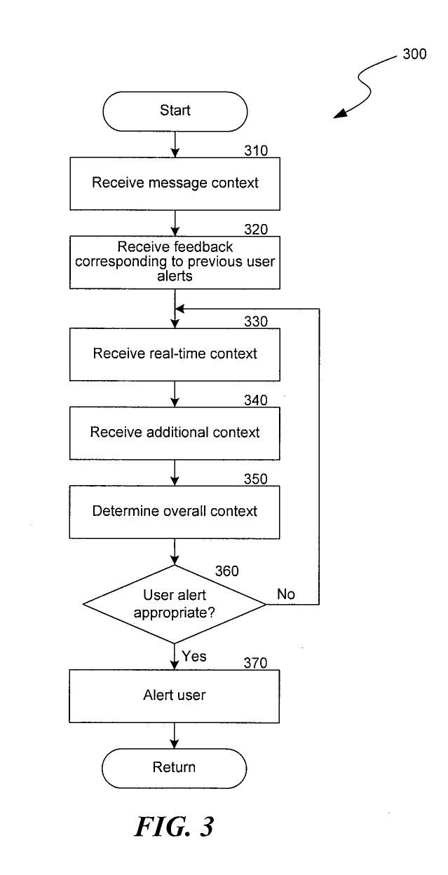

FIG. 3 illustrates process 300 for filtering messages based on various contexts. Process 300 may be implemented in software, in hardware, or in a combination of hardware and software. As such, the operations illustrated as blocks in FIG. 3 may represent computer-executable instructions which, when executed, direct a system to actively filter or otherwise manage incoming messages, including messages that have been flagged as advertisements or are suspected of being advertisements. For clarity, process 300 is described below as being performed by particular elements of system 200 of FIG. 2. However, process 300 may also be performed by other processors, by other elements, or in other systems, whether or not such processors, elements, or systems are described herein. Likewise, process 300 may be a real-time, near real-time, or non-real-time process.

At step 310, message context is provided to facility 210 by message context module 240. The message context may include the incoming message. At step 320, feedback from feedback module 260 is provided to facility 210. Next, at step 330, real-time context is received at facility 210 from real-time context module 230. At step 340, additional context module 250 also provides additional context to facility 210.

Processing continues at step 350 where the context information of steps 310-340 is analyzed to determine an overall context. The determined overall context is employed at decision block 360 to determine whether the user should be currently alerted to the arrival of the incoming message. Decision block 360 may make this determination based on whether the real-time context indicates that it is appropriate to alert the user (e.g., the user is in a receptive state to review the incoming message). If an alert is currently appropriate, facility 210 alerts the user. For example, facility 210 may alert the user by notifying the user of the incoming message and/or by presenting the incoming message to the user. In any case, the incoming message may also be stored for later review, stored for archival purposes, deleted, and/or the like.

If decision block 360 determines that it is currently inappropriate to alert the user, processing returns to step 330 such that facility 210 may continue monitoring the real-time context and additional contexts for changes indicating that a user alert has become appropriate (e.g., the end of the user's business meeting, the end of a telephone call, etc.). Facility 210 may then flow to step 370 to alert the user. Facility 220 may also provide silent, discreet, and/or passive notification to the user to inform them that one or more messages are available for presentation (e.g., an indicator shown on the display or a subtle background sound that is played), thus allowing the user to explicitly select the messages for presentation when the user desires. From step 370, processing may return to other actions. However, from step 370, processing may instead flow to step 310 to iteratively process any number of incoming messages.

Those skilled in the art will appreciate that the blocks shown in FIG. 3 may be altered in a variety of ways. For example, the order of blocks may be rearranged, sub-steps may be performed in parallel, shown blocks may be omitted, or other blocks may be included, etc.

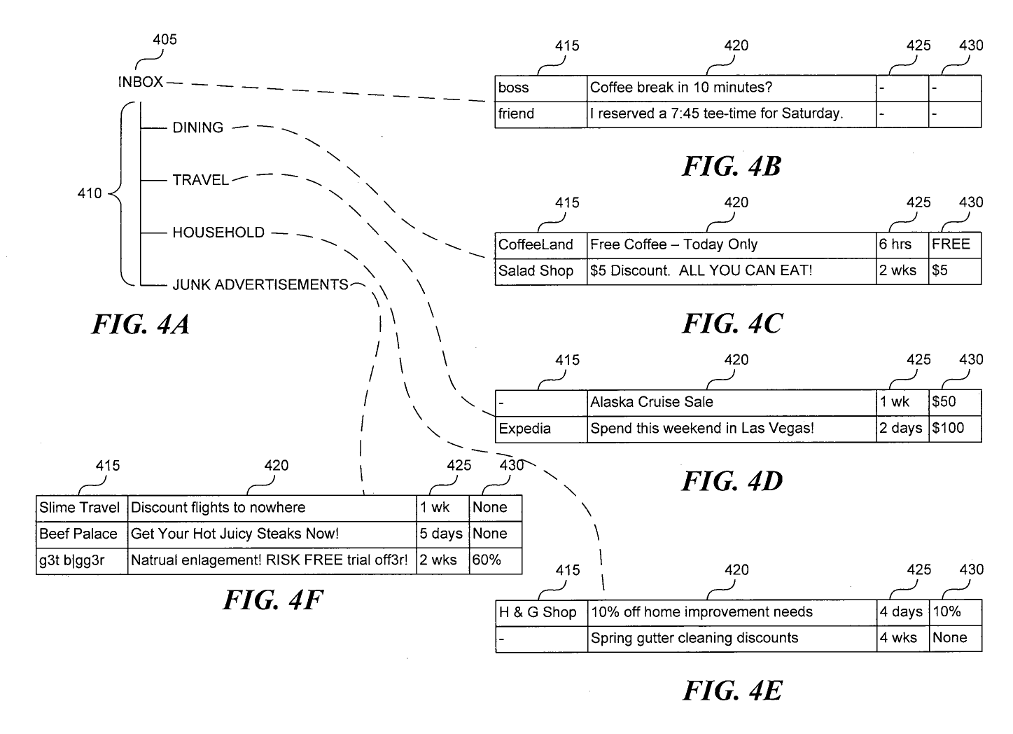

FIGS. 4A-4F illustrates organizational structure 400 into which received messages may be filtered. As shown, FIG. 4A illustrates structure 400 including inbox 405. Inbox 405 includes folders 410, including a dining folder, a travel folder, a household folder, and a junk advertisements folder. FIG. 4B illustrates exemplary inbox messages. FIG. 4C illustrates exemplary dining advertisements. FIG. 4D illustrates exemplary travel advertisements. FIG. 4E illustrates exemplary household advertisements. Finally, FIG. 4F illustrates exemplary junk advertisements. While FIGS. 4A-4F illustrate one example of an organizational structure, other structures may include any number and/or type of folders and may be organized in any number of different ways. For example, other structures may include automotive, housing, and entertainment folders. Likewise, other structures may employ a flat folder structure, a multitiered hierarchy structure (e.g., airline, lodging, and car rental folders under the travel folder), a tagging based organization structure, and/or the like.

Each of FIGS. 4B-4F also illustrates a sender field 415, a subject field 420, an expiration field 425, and a discount field 430. However, other structures may include any other fields. For example, a message text field, various flag fields, a received time field, an event time field, and/or the like may also be provided. As discussed above, facility 210 can also sort incoming messages into folders 410 based on flags contained within or corresponding to incoming messages. For example, advertisements having preapproved advertisement flags may be stored in the inbox or other high priority folder. Likewise, advertisements that have not been flagged as preapproved advertisements may be stored in the junk advertisements folder.

However, the above example is merely one illustration of the operations of facility 210. Facility 210 may also “intelligently” sort messages into folders 410 based on message context. For example, this may include determining the nature of the advertisement, the value of the advertisement, the advertisement expiration time, and/or the like. Facility 210 may also sort advertisements based on the likely usefulness of the advertisement to the user. Advertisements that are deemed likely to be useful to the user may be placed in the inbox or into specific folders for user review. Advertisements that are deemed unlikely to be useful to the user may be placed into the junk advertisements folder and/or deleted.

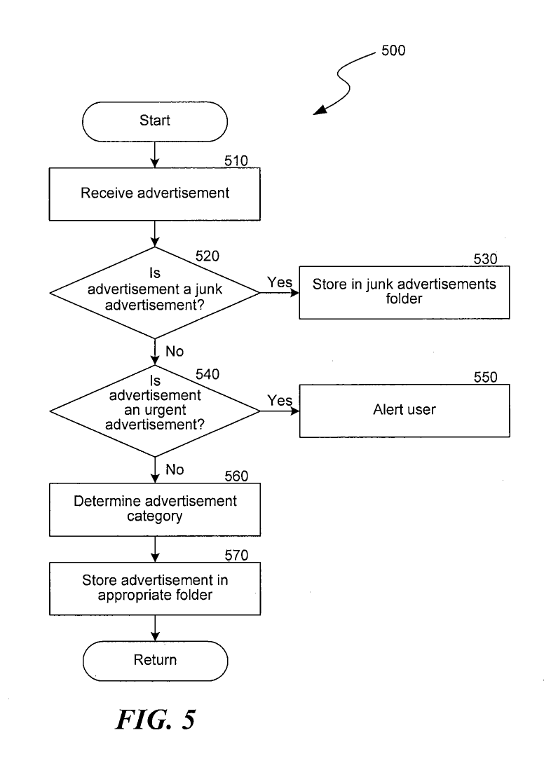

FIG. 5 illustrates process 500 for sorting advertisements. Process 500 may be implemented in software, in hardware, or in a combination of hardware and software. As such, the operations illustrated as blocks in FIG. 5 may represent computer-executable instructions that, when executed, direct the sorting of incoming advertisements. For clarity, process 500 is described below as being performed by particular elements of system 200 of FIG. 2 to sort advertisements into the organizational structure of FIGS. 4A-4F. However, process 500 may also be performed by other processors, by other elements, or in other systems, whether or not such processors, elements, or systems are described herein. However, process 500 may also be employed to sort any other type of messages into any type of organizational structure. Process 500 may also be a real-time, near real-time, or non-real-time process.

At step 510, facility 210 receives an incoming advertisement. Facility 210 then, at decision block 520, determines whether the received advertisement is a junk advertisement (e.g., unlikely to ever be useful to the user, unwelcome advertisement, etc.). If the received advertisement is determined to be a junk advertisement, it is stored in the junk advertisements folder at step 530. Alternately, junk advertisements may be deleted and/or stored in other folders. If, however, the received advertisement is determined to be a useful advertisement, processing continues to decision block 540.

At decision block 540, facility 210 determines whether the received advertisement is an urgent advertisement. For example, this determination may be based on an urgent flag, expiration data within the advertisement, other context information, and/or the like. If the received advertisement is determined to be an urgent advertisement, the user is alerted at step 550. As discussed above, user alerts may include notification of the advertisement arrival and/or presentation of the advertisement.

However, if the received advertisement is not an urgent advertisement, processing may flow to step 560 where facility 210 determines a category for the received advertisement. As one example, received advertisements may be placed into categories corresponding to folders 410 of FIG. 4A. At step 570, received advertisements are stored in the appropriate folders, as determined in step 560. In other examples, from step 530, 550, and/or 570, processing may flow to step 510 to iteratively process any number of advertisements.

Those skilled in the art will appreciate that the blocks shown in FIG. 5 may be altered in a variety of ways. For example, the order of blocks may be rearranged, sub-steps may be performed in parallel, shown blocks may be omitted, or other blocks may be included, etc.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples, and alternative implementations may employ differing values or ranges. Those skilled in the art will also appreciate that the actual implementation of a database may take a variety of forms, and the term “database” is used herein in the generic sense to refer to any data structure that allows data to be stored and accessed.

We claim:

1. A method for filtering advertisements in messages, comprising:
receiving a message;
determining a real-time context including:
extracting at least one of natural language information that is based on a user interaction with a mobile device or sentiment information that is based on the user interaction with the mobile device; and
providing the real-time context based on the extracted information;
determining a message context based on the received message; and
selectively providing a user alert based on the determined real-time context and the determined message context.

2. The method of claim 1, further comprising:
receiving user feedback corresponding to the selectively provided user alert;
determining a feedback context based on the received user feedback;
receiving another message; and
selectively providing another user alert based on the determined feedback context.

3. The method of claim 2, wherein the user feedback corresponding to the selectively provided user alert includes information related to a user response to the selectively provided user alert.

4. The method of claim 1, wherein the user alert includes at least one of notifying a user of the received message or presenting the received message to the user.

5. The method of claim 1, further comprising:
selectively storing the received message based on the determined real-time context and the determined message context.

6. The method of claim 1, wherein extracting at least one of natural language information or sentiment information includes:
extracting the natural language information; and
extracting the sentiment information.

7. The method of claim 1, wherein extracting at least one of natural language information or sentiment information includes:
receiving user speech data; and
extracting at least one of the natural language information or the sentiment information from the received user speech data.

8. The method of claim 1, wherein determining the real-time context further includes:
determining ancillary information including at least one of a location of the mobile device, a speed of the mobile device, or a time at the mobile device, and wherein providing the real-time context is further based on the determined ancillary information.

9. The method of claim 1, wherein determining the real-time context further includes:
determining environmental information including at least one of ambient temperature information, body temperature information, heart rate information, humidity information, pressure information, weather information, traffic condition information, or information relating to proximity of the mobile device to other mobile devices, and wherein providing the real-time context is further based on the determined environmental information.

10. The method of claim 1, further comprising:
determining an additional context based on at least one of a mobile identifier, a user identifier, a user preference, or a user schedule, wherein selectively providing the user alert is further based on the additional context.

11. The method of claim 1, wherein determining the message context is further based on an inclusion status of an approved advertisement flag of the received message, wherein inclusion of the approved advertisement flag with the received message indicates that the received message includes a preapproved advertisement.

12. The method of claim 1, wherein the received message includes an advertisement.

13. A processor-readable medium containing instructions for executing a method of filtering advertisements in messages, wherein the method comprises:
receiving a message;
determining a real-time context including:
extracting at least one of natural language information that is based on a user interaction with a mobile device or sentiment information that is based on the user interaction with the mobile device from received user speech data; and
determining ancillary information including at least one of a location of the mobile device, a speed of the mobile device, or a time at the mobile device; and
providing the real-time context based on the extracted information and the ancillary information;
determining a message context based on the received message and an inclusion status of an approved advertisement flag of the received message, wherein inclusion of the approved advertisement flag with the received message indicates that the received message includes a preapproved advertisement;
determining an additional context based on at least one of a mobile identifier, a user identifier, a user preference, or a user schedule; and
selectively providing a user alert based on the determined real-time context, the determined message context, and the determined additional context;
receiving user feedback corresponding to the selectively provided user alert;
determining a feedback context based on the received user feedback;
receiving another message; and
selectively providing another user alert based on the determined feedback context.

14. The processor-readable medium of claim 13, wherein extracting at least one of natural language information or sentiment information includes:
receiving user speech data;
extracting natural language information from the received user speech data; and
extracting sentiment information from the received user speech data.

15. The processor-readable medium of claim 13, wherein determining the real-time context further includes:
determining environmental information including at least one of ambient temperature information, body temperature information, heart rate information, humidity information, pressure information, weather information, traffic condition information, or information relating to proximity of the mobile device to other mobile devices, wherein providing the real-time context is further based on the determined ancillary and the determined environmental information, and wherein selectively providing the user alert is further based on the additional context.

16. A computing system configured to filter advertisements in messages, comprising:
a memory;
a first module configured, when executed in the memory, to receive a message;
a second module configured, when executed in the memory, to determine a real-time context by:
extracting at least one of natural language information that is based on a user interaction with a mobile device or sentiment information that is based on the user interaction with the mobile device; and
providing the real-time context based on the extracted information;
a third module configured, when executed in the memory, to determine a message context based on the received message; and
a fourth module configured, when executed in the memory, to selectively provide a user alert based on the determined real-time context and the determined message context.

17. The computing system of claim 16, wherein extracting at least one of natural language information or sentiment information includes:
receiving user speech data;
extracting natural language information from the received user speech data; and
extracting sentiment information from the received user speech data.

18. The computing system of claim 16, further comprising:
a fifth module configured, when executed in the memory, to receive user feedback corresponding to the selectively provided user alert;
a sixth module configured, when executed in the memory, to determine a feedback context based on the received user feedback;
a seventh module configured, when executed in the memory, to receive another message; and
an eighth module configured, when executed in the memory, to selectively provide another user alert based on the determined feedback context.

19. The computing system of claim 16, wherein the user feedback corresponding to the selectively provided user alert includes information related to a user response to the selectively provided user alert.

20. The computing system of claim 16, wherein determining the message context is further based on an inclusion status of an approved advertisement flag of the received message, wherein inclusion of the approved advertisement flag with the received message indicates that the received message includes a preapproved advertisement.
